(19) United States
(12) Patent Application Publication
(10) Pub. No.: US 2022/0099454 A1
(43) Pub. Date: Mar. 31, 2022

(54) NAVIGATION STREET VIEW TOOL

(71) Applicant: International Business Machines Corporation, Armonk, NY (US)

(72) Inventors: Clement Decrop, Arlington, VA (US); Jeremy R. Fox, Georgetown, TX (US); Zachary A. Silverstein, Jacksonville, FL (US); Lisa Seacat DeLuca, Baltimore, MD (US)

(21) Appl. No.: 17/036,445

(22) Filed: Sep. 29, 2020

(51) Int. Cl. G01C 21/36

(52) U.S. Cl. CPC G01C 21/3647; G01C 21/3691; G01C 21/3638; G01C 21/367

(57) ABSTRACT

Embodiments of the present invention provide methods, computer program products, and systems. Embodiments of the present invention can dynamically generate one or more images associated with a location based on contextual information that satisfies a request. Embodiments of the present invention can then display the dynamically generated one or more images on a user device. Embodiments of the present invention can then navigate a user to the location using the dynamically generated one or more images.

### BACKGROUND

The present invention relates in general to navigation systems and in particular to creating a more accurate street view in a navigation user interface.

In general, navigation systems can determine the position of a user from radio signals of satellites. Typically, navigation systems receive radio signals, calculate a user's position, and route a user to an intended destination. In some instances, navigation systems have features that allow a user to sort route preferences by shortest route and fastest route. In other instances, navigation systems have features to avoid certain locations (e.g., toll roads).

A web mapping service can typically offer satellite imagery, aerial photography, street maps, 360° interactive panoramic views of streets (Street View), real-time traffic conditions, and route planning for traveling by foot, car, bicycle and air (in beta), or public transportation. In some instances, mapping services can include crowdsourced contributions. In general, mapping services can offer a “top-down” or bird's-eye view and can include high-resolution imagery of cities that is collected by aerial photography taken from aircraft flying. Most other imagery is from satellites or 3d Video Stereo streams, coupled with Fish-eye Video sensors for panoramic streams, or matrix Lidar video images on continuous basis across the world. Typically, satellite imagery is updated on a regular basis. For constellation wide continuous videography images, Astronomical Telescopic cameras stationed on observatories or mounted on satellites and continuous images captured by the astronomical missions.

### SUMMARY

According to an aspect of the present invention, there is provided a computer-implemented method. The method comprises dynamically generating one or more images associated with a location based on contextual information that satisfies a request; displaying the dynamically generated one or more images on a user device; and navigating a user to the location using the dynamically generated one or more images.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps for navigating a user to an intended location, in accordance with an embodiment of the present invention;

FIG. 3 is a flowchart depicting operational steps for generating contextual images, in accordance with an embodiment of the present invention;

FIGS. 4A and 4B depict example images generated for using a navigation tool, in accordance with an embodiment of the present invention; and

FIG. 5 is a block diagram of an example system, in accordance with an embodiment of the present invention.

### DETAILED DESCRIPTION

Embodiments of the present invention recognize deficiencies navigation and mapping systems. Specifically, embodiments of the present invention recognize that navigation and mapping services typically lack comprehensive ways to display contextual information that enables easier and more efficient navigation experience for the user. For example, traditional navigation and mapping systems can navigate a user from one location to another and can even display an image associated with the location that the user is being navigated to. However, traditional images with locations are static, that is, images used by traditional navigation and mapping systems cannot account for conditions that may render the image of little use to the user. For example, a daytime image of a location may not be easily spotted when the user is navigating to the location as night. As such, embodiments of the present invention provide solutions for the deficiencies of navigation systems (particularly to user interfaces of those navigation systems) by providing a mechanism to display computer rendered views of a location that are contextually relevant to the user's viewpoint and current perspective as discussed in greater detail, later in this Specification.

Contextual information, as used herein, refers to information regarding a location (e.g., an intended destination). For example, contextual information can include weather data (e.g., sun/rain/snow, humidity, cloud index, UV index, wind, dew point, pressure, visibility, etc.), luminosity (e.g., sun's position), time, GPS location, quantity of users in a location). Contextual information can further include information regarding objects at or within a proximity to a location (e.g., geotags for certain street signs, lights, billboards, benches, etc.).

Contextual information can also include information about a location (e.g., location information) and changes to information pertaining to navigation to and from the location. For example, location information can include hours of operation of a building, road closures, anticipated traffic based on scheduled events such as concerts, real-time traffic, queue status of locations such as restaurant wait times, user preferences, etc.

Embodiments of the present invention can utilize contextual information with permission from users via crowdsourced data. For example, embodiments of the present invention can provide users with an opt-in/opt-out mechanism that allows embodiments of the present invention to collect and use information provided by the user (e.g., user-uploaded images, user-generated tags, user copyright images, etc.). Some embodiments of the present invention can transmit a notification to the user each time information is collected or otherwise used.

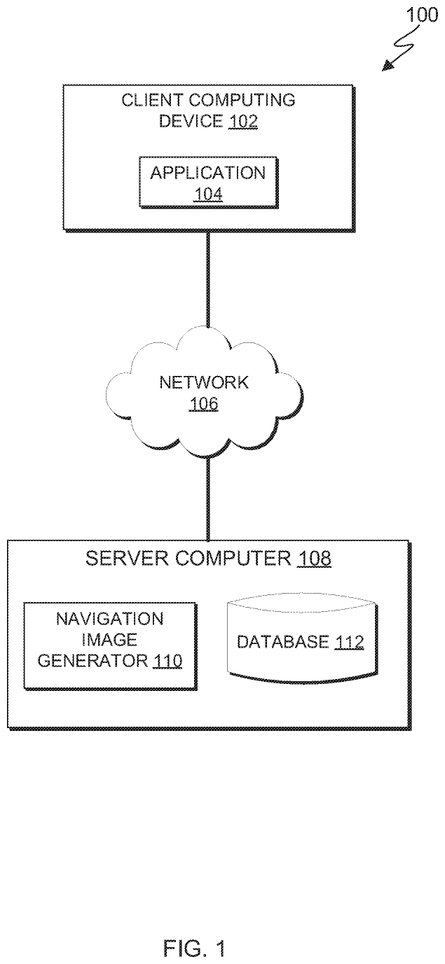

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

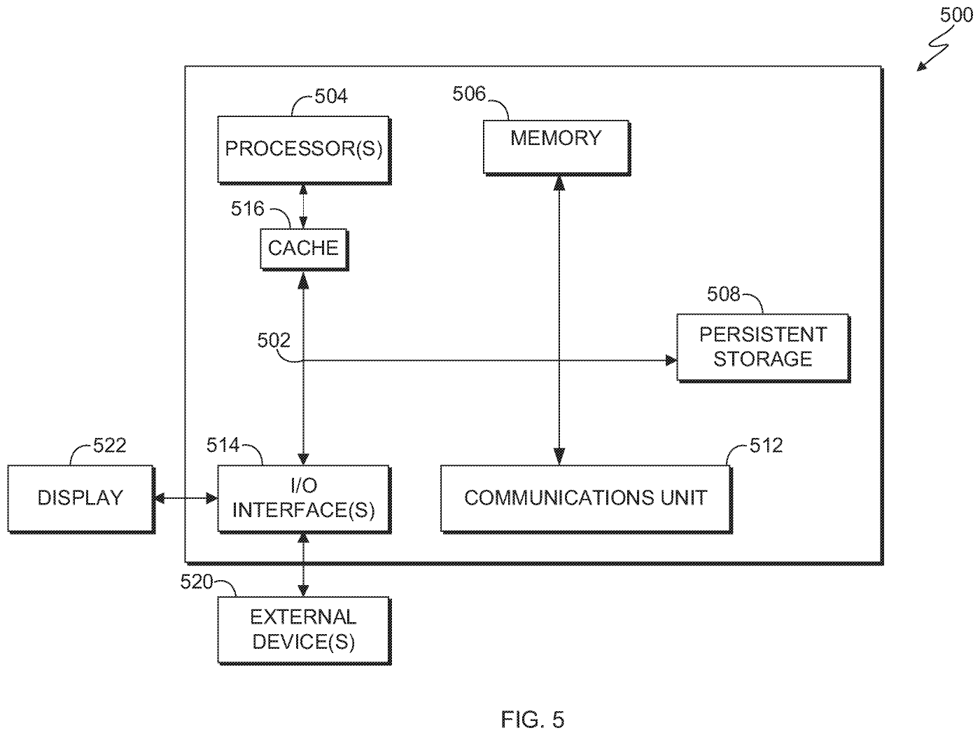

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 5.

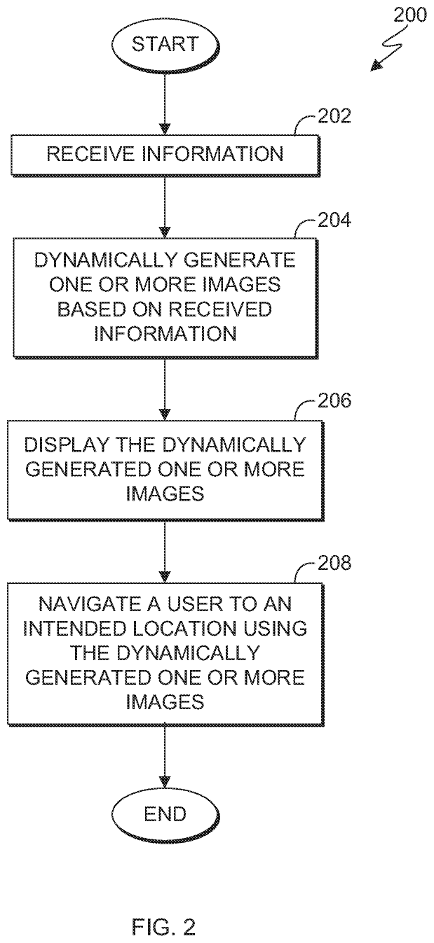

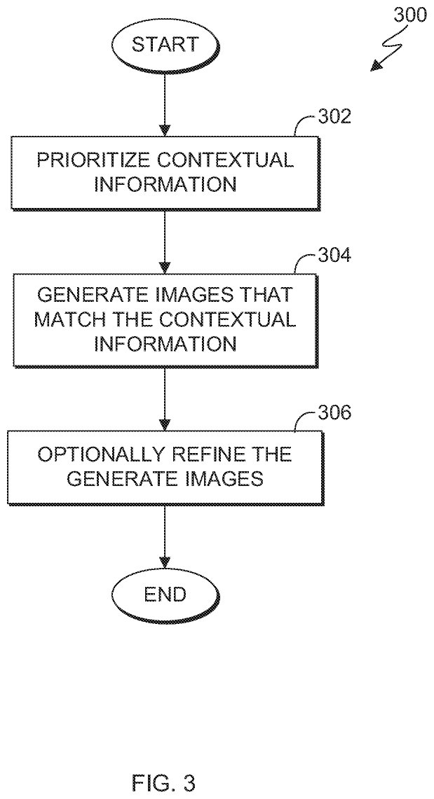

In this embodiment, client computing device 102 is a user device associated with a user and includes application 104. Application 104 communicates with server computer 108 to access navigation image generator 110 (e.g., using TCP/IP) to access content, user information, and database information. Application 104 can further communicate with navigation image generator 110 to transmit instructions to generate and subsequently display computer rendered views of a location comprising one or more graphic icons that are contextually relevant to the user's viewpoint and current perspective as discussed in greater detail with regard to FIGS. 2-3.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts navigation image generator 110 and database 112. In this embodiment, navigation image generator 110 resides on server computer 108. In other embodiments, navigation image generator 110 can have an instance of the program (not shown) stored locally on client computer device 102. For example, navigation image generator 110 can be integrated with an existing navigation or mapping service system installed on a client device. In other embodiments, navigation image generator 110 can be a standalone program or system that generates one or more contextually relevant images for a user and subsequently navigates the user to an intended location using the generated contextually relevant images. In yet other embodiments, navigation image generator 110 can be stored on any number or computing devices.

In this embodiment, navigation image generator 110 generates and subsequently displays computer rendered views of a location that is contextually relevant to the user's viewpoint and current perspective. For example, navigation image generator 110 dynamically generates one or more images based on received information, display the dynamically generated one or more images, and navigate a user to an intended location using the dynamically generated one or more images.

In this embodiment, received information refers generally to a received request to navigate to an intended location. Received information can include location information (e.g., hours of operation of a building, road closures, anticipated traffic based on scheduled events such as concerts, real-time traffic, queue status of locations such as restaurant wait times, user preferences, etc.), changes to information pertaining to navigation to and from the intended location (e.g., crowdsourced location information that include road closures, predicted and actual traffic, changes to hours of operation).

Received information can also include contextual information. For example, received information can also include weather data (e.g., sun/rain/snow, humidity, cloud index, UV index, wind, dew point, pressure, visibility, etc.), luminosity (e.g., sun's position), time, GPS location, quantity of users in a location). Contextual information can further include information regarding objects at or within a proximity to a location (e.g., geotags for certain street signs, lights, billboards, benches, etc.).

Finally, received information can also include user-generated content associated with the location as well as publicly available content. Specifically, received information can include one or more images associated with a location from one or more multiple perspectives and respective points in time. For example, user-generated content associated with a location can include multiple perspectives (e.g., different angles of the same location depicting multiple points of entry and multiple street views) at different points in time (e.g., during the day or night time).

Content can include one or more textual information, pictorial, audio, visual, and graphic information. Content can also include one or more files and extensions (e.g., file extensions such as .doc, .docx, .odt, .pdf, .rtf.txt, .wpd, etc. Content can further include audio (e.g., .m4a, .flac, .mp3, .mp4, .wave .wma, etc.) and visual/images (e.g., .jpeg, .tiff, .bmp, .pdf, .gif etc.).

In this embodiment, navigation image generator 110 can then generate one or more images using the received information. In this embodiment, navigation image generator 110 generates one or more images by determining contextually relevant information, prioritizing the relevant information, and generating images that match the contextual information as discussed in greater detail with respect to FIGS. 2 and 3. For example, a user can request navigation directions to Location A during the day but may approach the location during night time. In this scenario, navigation image generator 110 can alter the image of the location, shown in a view mode (e.g., street-view) to display the image of the location during the nighttime.

In some embodiments, navigation image generator 110 can recognize certain objects depicted with received images of the location and target those recognized objects for image altering. For example, Location A can include a neon sign depicting Location A's business logo. Navigation image generator 110 can recognize the neon sign as an object and target the neon sign for image altering. In this example, navigation image generator 110 can identify the color of the neon sign being displayed at specific points in time and at different light levels. Navigation image generator 110 can change the color of the neon sign having no color during the day time to orange (e.g., the color shown in images at night) and subsequently display the altered image as part of a user interface depicting the navigation route. In instances where the object can have multiple colors (e.g., the neon sign flashing one or more colors), navigation image generator 110 can generate a graphics interchange format image to show the shifting colors. In instances where no color (e.g., unknown) of an object can be identified, navigation image generator 110 can assign the object a random color. For example, navigation program 110 can assign the color blue to signs with words or numbers and either a yellow or white light for any other non-recognizable light source/object.

In other embodiments, navigation image generator 110 can generate one or more graphic icons associated with identified objects associated with the location. In this embodiment, navigation image generator 110 can identify objects associated with the location to be one or more objects that can aid in navigation to the intended location. For example, identified objects can include streetlights, business logos, digital and traditional billboards, objects capable of displaying light or color, etc.

Navigation image generator 110 can then display the one or more generated graphic icons or otherwise overlay the one or more generated graphic icons over the altered image. Continuing the example, above, navigation image generator 110 can generate an icon that highlights or otherwise flags the neon sign and entrance (e.g., identified objects) associated with the location. Navigation image generator 110 can then generate subsequent images at the user's request to show different perspectives of the same location.

Navigation image generator 110 can then optionally refine the generated images. In this embodiment, navigation image generator 110 can refine images using an iterative feedback loop. For example, navigation image generator 110 can include a mechanism to solicit feedback from users to indicated either satisfaction (e.g., that the generated images aided in navigation to the intended location) or dissatisfaction (e.g., that the generated images did not aid in navigation to the intended location). Navigation image generator 110 can further solicit feedback based on the user's perceived accuracy of the generated image. For example, navigation image generator 110 can solicit feedback with respect to accuracy of colors used, filters used, graphic icons generated, etc.

Navigation image generator 110 can verify authenticity of user feedback by authenticating users within a certain radius of the location within a specified time frame. For example, in this embodiment, navigate image generator 110 can authenticate a user as being verified if the user is within a one-mile radius of the location while providing feedback. In some embodiments, navigation image generator 110 may limit feedback to a specified time period (e.g., within one hour of completion of a navigation route to the intended location). In other embodiments, the specified radius may be configured to any optimal radius or proximity to the intended location.

Database 112 stores received information and can be representative of one or more databases that give permissioned access to navigation image generator 110 or publicly available databases. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting operational steps for navigating a user to an intended location, in accordance with an embodiment of the present invention.

In step 202, navigation image generator 110 receives information. In this embodiment, navigation image generator 110 receives a request from client computing device 102. In other embodiments, navigation image generator 110 can receive information from one or more other components of computing environment 100.

In this embodiment, information can include a request to navigate to a location (e.g., by a user). The request can specify other contextual information or, in other embodiments, navigation image generator 110 can accesses other permissioned or otherwise publicly available databases for contextual information.

Examples of contextual information can include location information (e.g., hours of operation of a building, road closures, anticipated traffic based on scheduled events such as concerts, real-time traffic, queue status of locations such as restaurant wait times, user preferences, etc.), changes to information pertaining to navigation to and from the intended location (e.g., crowdsourced location information that include road closures, predicted and actual traffic, changes to hours of operation).

Received information can also include weather data (e.g., sun/rain/snow, humidity, cloud index, UV index, wind, dew point, pressure, visibility, etc.), luminosity (e.g., sun's position), time, GPS location, quantity of users in a location). Contextual information can further include information regarding objects at or within a proximity to a location (e.g., geotags for certain street signs, lights, billboards, benches, etc.).

Finally, received information can also include user-generated content associated with the location as well as publicly available content. Specifically, received information can include one or more images associated with a location from one or more multiple perspectives and respective points in time. For example, user-generated content associated with a location can include multiple perspectives (e.g., different angles of the same location depicting multiple points of entry and multiple street views) at different points in time (e.g., during the day or night time).

In step 204, navigation image generator 110 dynamically generates one or more images based on received information. In this embodiment, navigation image generator 110 can reference existing images associated with the intended location and leverage one or more artificial intelligence algorithms and Generative Adversarial Networks (GANs) to alter existing images or generate entirely new images of the intended location based on contextual information as discussed in greater detail with respect to FIG. 3.

For example, a user may transmit a request to navigate to Location A. Navigation image generator 110 can receive information (e.g., contextual information) that indicates the user will be arriving at nighttime. Navigation image generator 110 can then alter a daytime view of Location A to show what Location A would look like at night.

Optionally, navigation image generator 110 can alter objects associated with the location. Continuing the example above, navigation image generator 110 can identify a neon sign depicting a business logo associated with Location A and another illuminated sign indicate that Location A is “open” using a combination of natural language processing and object recognition techniques. Navigation image generator 110 can then add color to the neon sign and illuminated sign that is representative of the color the user would see when arriving at Location A.

In another example, navigation image generator 110 can account for contextual information such as snow to alter the displayed image to show what the location and associated objects of the location would look like with snow either freshly laid or plowed. In yet other embodiments, navigation image generator 110 can receive crowdsourced information that there is a large gathering of individuals (e.g., for a concert) and generate computer images of one or more generic individuals representing a crowd within proximity of the location.

In step 206, navigation image generator 110 displays the dynamically generated one or more images. In this embodiment, navigation image generator 110 displays the dynamically generated one or more images on a user device. In instances where navigation image generator 110 has altered an image to better show objects (e.g., illuminated objects, signs, text, etc.), navigation image generator 110 can replace the original image with the generated image.

In other embodiments, navigation image generator 110 can be integrated into an existing navigation or mapping service. In those instances, navigation image generator 110 can overlay the generated image over the existing image for the location. For example, where the generated image contains one or more graphical icons, navigation image generator 110 can overlay the generated graphic icons over the original image associated with the icon.

In step 208, navigation image generator 110 navigates a user to an intended location using the dynamically generated one or more images. In this embodiment, navigation image generator 110 navigates a user to an intended location using the dynamically generated one or more images and a combination of GPS, Near Field Communication (NFC), Bluetooth, Radio Frequency Identification (RFID) signals to show movement or progress of a user to the intended location. In certain embodiments, navigation image generator 110 can generate a graphic icon representing the user and place the graphic icon on the generated image and refresh the image to show movement of the graphic icon that is proportional to the movement of the user to the intended location.

FIG. 3 is a flowchart 300 depicting operational steps for generating contextual images, in accordance with an embodiment of the present invention.

In step 302, navigation image generator 110 prioritizes contextual information. In this embodiment, navigation image generator 110 prioritizes contextual information according to user preferences. For example, navigation image generator 110 can access user preferences that includes an order of displayed objects and luminosities the user prefers (e.g., that a user prefers daytime views during the day and nighttime views during the night, that a user prefers illuminated signs and entrances to be shown). In other embodiments, navigation image generator 110 can use one or more artificial intelligence and machine learning algorithms to determine priorities of contextual information.

In step 304, navigation image generator 110 generate images that match the contextual information. In this embodiment, navigation image generator 110 generate images that match the contextual information by matching identified contextual factors to one or more images displaying contextual factors. For example, navigation image generator 110 can receive a request to display images of an intended location. Navigation image generator 110 can receive and subsequently prioritize received contextual information. For example, in instances where navigation image generator 110 receives contextual information detailing the user will arrive or is scheduled to arrive at nighttime, when there is no more sunlight, navigation image generator 110 can find a matching image of the location depicted at nighttime to display.

Navigation image generator 110 can then identify objects depicted in the matching image and select the identified objects for alteration. For example, navigation image generator 110 can identify a neon sign depicting a business logo associated with Location A and another illuminated sign indicate that Location A is “open” using a combination of natural language processing and object recognition techniques and identify both signs as objects associated with the location. Navigation image generator 110 can then add color to the neon sign and illuminated sign that is representative of the color the user would see when arriving at the location.

In instances where there is no known image matching the contextual information, navigation image generator 110 can generate one or more images by leveraging one or more artificial intelligence algorithms and Generative Adversarial Networks (GANs). For example, where no, nighttime image of a location is located, navigation image generator 110 can apply one or more filters to mimic a nighttime environment of the location and subsequently alter the image to better show objects (e.g., illuminated objects, signs, text, etc.), navigation image generator 110 can replace the original image with the generated image.

In step 306, navigation image generator 110 optionally refines the generated images. In this embodiment, navigation image generator 110 can refine images using an iterative feedback loop. For example, navigation image generator 110 can include a mechanism to solicit feedback from users to indicated either satisfaction or dissatisfaction. In certain embodiments, navigation image generator 110 can generate questions to further solicit feedback based on the user's perceived accuracy of the generated image. For example, navigation image generator 110 can solicit feedback with respect to accuracy of colors used, filters used, graphic icons generated, etc.

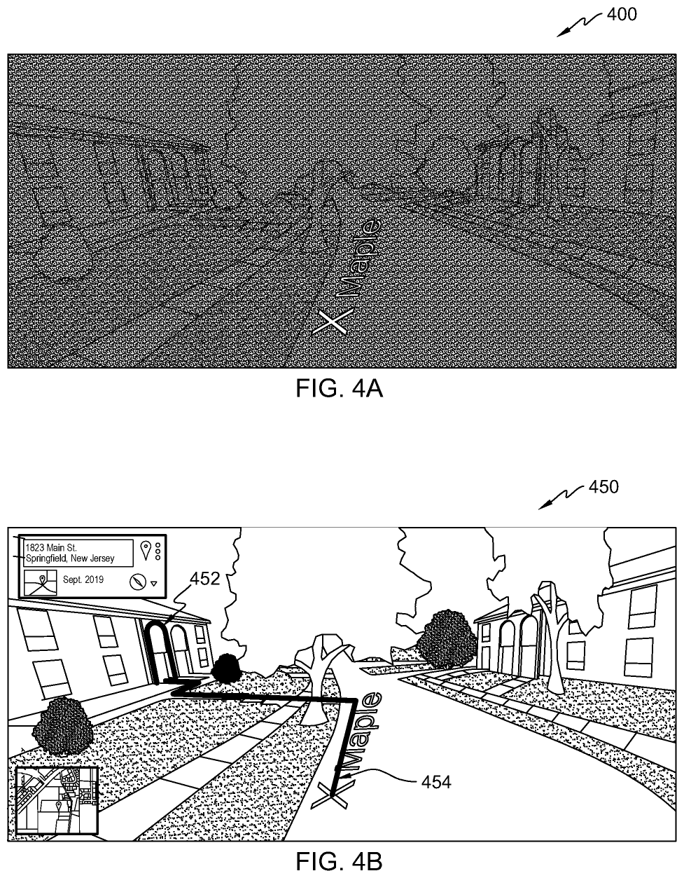

FIGS. 4A and 4B depict example images generated for using a navigation tool, in accordance with an embodiment of the present invention.

FIG. 4A depicts image 400 that represents an image depicting a street view of the user's intended location. No markers are shown. The image displayed is shown during nighttime. Objects associated with the intended location as well as entrance ways for the intended location are not highlighted and are difficult to see.

FIG. 4B depicts image 450 that represents an altered image depicting a street view of the user's intended location.

In this example, navigation image generator 110 has modified image 400 of FIG. 4A and produced image 450 in response to receiving a request from a user. In this example, navigation image generator 110 has determined that image 400 depicted a nighttime view of the intended location (originally displayed for the user when the user first looked up directions to the intended location). In this example however, navigation image generator 110 receives contextual information identifying that the user is scheduled to arrive at the intended location (e.g., is currently in route to the intended location) during the daytime. Navigation image generator 110 can accordingly alter image 400 to display image 450 which depicts graphical icons 452 and 454. Graphical icon 452 illustrates the entrance associated with the intended location. Graphical icon 454 highlights a route to take to the entrance of the intended location. Additionally, in this example, navigation image generator 110 has alerted the image to show what the street view would look like during the daytime.

In other examples, not shown, navigation image generator 110 can conversely modify images displayed during the day to display a nighttime view. Navigation image generator 110 can further highlight other objects associated with the intended location (e.g., signs, lights, logos, etc.) as previously discussed with respect to FIGS. 1-3. In other examples, navigation image generator 110 can in addition, add color to highlighted objects. Specifically, navigation image generator 110 can identify a sign capable of emitting light (e.g., a neon sign) associated with the logo that is unlit during the daytime. In response to determining the user is arriving at the location associated with the sign, navigation image generator 110 can overlay a graphic icon pointing out the neon sign and further alter the image to add color of the neon sign that is representative of the color that would be emitted by the sign during nighttime.

FIG. 5 depicts a block diagram of components of computing systems within computing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Navigation image generator 110 (not shown) may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links. Navigation image generator 110 may be downloaded to persistent storage 508 through communications unit 512.

I/O interface(s) 514 allows for input and output of data with other devices that may be connected to client computing device and/or server computer. For example, I/O interface 514 may provide a connection to external devices 520 such as a keyboard, keypad, a touch screen, and/or some other suitable input device. External devices 520 can also include portable computer readable storage media such as, for example, thumb drives, portable optical or magnetic disks, and memory cards. Software and data used to practice embodiments of the present invention, e.g., navigation image generator 110, can be stored on such portable computer readable storage media and can be loaded onto persistent storage 508 via I/O interface(s) 514. I/O interface(s) 514 also connect to a display 522.

Display 522 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
dynamically generating one or more images associated with a location based on contextual information that satisfies a request;
displaying the dynamically generated one or more images on a user device; and
navigating a user to the location using the dynamically generated one or more images.

2. The computer-implemented method of claim 1, further comprising:
optionally refining the dynamically generated one or more images.

3. The computer-implemented method of claim 2, further comprising:
verifying received input by authenticating input based on a radius of the location within a specified time frame.

4. The computer-implemented method of claim 1, wherein dynamically generating one or more images associated with a location based on contextual information comprises:
prioritizing contextual information associated with the location; and
generating one or more images that match the contextual information.

5. The computer-implemented method of claim 4, wherein generating one or more images that match the contextual information comprises:
identifying a plurality of objects within the generated one or more images; and
altering at least one object of the plurality of identified objects based on contextual information.

6. The computer-implemented method of claim 5, further comprising:
generating one or more graphical icons to be overlaid on the one or more generated images that represents at least one object of the plurality of objects; and
overlaying the at least one or more generated graphical icons over a generated image of the one or more generated images displayed on the user device.

7. The computer-implemented method of claim 5, wherein altering the one or more identified objects based on contextual information comprises:
identifying colors emitted by the object; and
altering the object to depict the identified color emitted by the object.

8. A computer program product comprising:
one or more computer readable storage media and program instructions stored on the one or more computer readable storage media, the program instructions comprising:
program instructions to dynamically generate one or more images associated with a location based on contextual information that satisfies a request;
program instructions to display the dynamically generated one or more images on a user device; and
program instructions to navigate a user to the location using the dynamically generated one or more images.

9. The computer program product of claim 8, wherein the program instructions stored on the one or more computer readable storage media further comprise:
program instructions to optionally refine the dynamically generated one or more images.

10. The computer program product of claim 9, wherein the program instructions stored on the one or more computer readable storage media further comprise:
program instructions to verify received input by authenticating input based on a radius of the location within a specified time frame.

11. The computer program product of claim 8, wherein the program instructions to dynamically generate one or more images associated with a location based on contextual information comprise:
program instructions to prioritize contextual information associated with the location; and
program instructions to generate one or more images that match the contextual information.

12. The computer program product of claim 11, wherein the program instructions to generate one or more images that match the contextual information comprise:
program instructions to identify a plurality of objects within the generated one or more images; and
program instructions to alter at least one object of the plurality of identified objects based on contextual information.

13. The computer program product of claim 12, wherein the program instructions stored on the one or more computer readable storage media further comprise:
program instructions to generate one or more graphical icons to be overlaid on the one or more generated images that represents at least one object of the plurality of objects; and
program instructions to overlay the at least one or more generated graphical icons over a generated image of the one or more generated images displayed on the user device.

14. The computer program product of claim 12, wherein the program instructions to alter the one or more identified objects based on contextual information comprise:
program instructions to identify colors emitted by the object; and
program instructions to alter the object to depict the identified color emitted by the object.

15. A computer system for comprising:
one or more computer processors;
one or more computer readable storage media; and
program instructions stored on the one or more computer readable storage media for execution by at least one of the one or more computer processors, the program instructions comprising:
program instructions to dynamically generate one or more images associated with a location based on contextual information that satisfies a request;
program instructions to display the dynamically generated one or more images on a user device; and
program instructions to navigate a user to the location using the dynamically generated one or more images.

16. The computer system of claim 15, wherein the program instructions stored on the one or more computer readable storage media further comprise:
program instructions to optionally refine the dynamically generated one or more images.

17. The computer system of claim 16, wherein the program instructions stored on the one or more computer readable storage media further comprise:
program instructions to verify received input by authenticating input based on a radius of the location within a specified time frame.

18. The computer system of claim 15, wherein the program instructions to dynamically generate one or more images associated with a location based on contextual information comprise:
program instructions to prioritize contextual information associated with the location; and
program instructions to generate one or more images that match the contextual information.

19. The computer system of claim 17, wherein the program instructions to generate one or more images that match the contextual information comprise:
program instructions to identify a plurality of objects within the generated one or more images; and
program instructions to alter at least one object of the plurality of identified objects based on contextual information.

20. The computer system of claim 18, wherein the program instructions stored on the one or more computer readable storage media further comprise:
program instructions to generate one or more graphical icons to be overlaid on the one or more generated images that represents at least one object of the plurality of objects; and
program instructions to overlay the at least one or more generated graphical icons over a generated image of the one or more generated images displayed on the user device.
